(19) United States
(12) Patent Application Publication
(10) Pub. No.: US 2010/0050081 A1
(43) Pub. Date: Feb. 25, 2010

(54) IMAGE PROCESSING APPARATUS, DISPLAY APPARATUS AND CONTROL METHOD OF DISPLAY APPARATUS

(75) Inventors: Ki-deok LEE, Seoul (KR); Bo-gun PARK, Suwon-si (KR); Youn-sook JUNG, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 12/464,263

(22) Filed: May 12, 2009

(30) Foreign Application Priority Data
Aug. 25, 2008 (KR) 10-2008-0083029

(51) Int. Cl. G06F 3/00; H04N 5/45

(52) U.S. Cl. 715/719; 348/565

(57) ABSTRACT

An image processing apparatus, a display apparatus and a control method of the display apparatus are provided. The display apparatus includes: a communication unit which receives a first image from an image processing apparatus; an image processing unit which processes the first image which is received through the communication unit and a second image; a display unit which displays the first image and the second image which are processed by the image processing unit; and a control unit which controls the image processing unit so that the second image which is displayed in the display unit can be adjusted depending on a control of the image processing apparatus. Thus, the present invention provides a method and an apparatus using a strong image system of a television in a personal computer screen like an application.

### CROSS-REFERENCE TO RELATED APPLICATION

This application claims priority from Korean Patent Application No. 10-2008-0083029, filed on Aug. 25, 2008 in the Korean Intellectual Property Office, the disclosure of which is incorporated herein by reference.

### BACKGROUND OF INVENTION

1. Field of Invention

Exemplary embodiments of the present invention relate to an image processing apparatus, a display apparatus and a control method of the display apparatus, and more particularly, to an image processing apparatus, a display apparatus and a control method of the display apparatus embodying a strong multimedia system of the display apparatus, and concurrently, conveniently controlling a multimedia system embodied in the display apparatus through the image processing apparatus by interaction between the image processing apparatus and the display apparatus.

2. Description of Related Art

As a digital television (TV) becomes common, and various functions such as an internet function, etc. are provided to the digital TV, the digital TV currently occupies a central device of a home media. Recently, the digital TV supplies a web surfing or a data service to a user through a network connected to the digital TV as well as just supplies a broadcasting service, and besides, a user is capable of replaying a motion picture in the digital TV by using a universal serial bus (USB) device, etc. Like this, the digital TV has increased the role as a media device and a system power thereof.

A user wanting to connect a personal computer (PC) to a digital TV to use a function of the PC has increased. Since the PC supplies a motion picture service, the PC itself includes a motion picture replaying device and an external input device for operating as a media device. However, these devices are incapable of supplying use convenience, stability, image quality, etc. which a strong image system of the digital TV is capable of supplying. For example, if a user wants to display an image currently broadcasted or a contents supplied from an external set top box while doing word processing, web surfing or the like through a PC screen, the user should exit the PC screen. Also, the user cannot but view the image currently broadcasted or the contents through a screen having a stationary position and a restricted size by using a picture in picture (PIP) function which the digital TV supplies.

Although need and necessity for using a strong function which the digital TV has while using the PC increase, a system satisfying this has not been supplied yet.

### SUMMARY OF INVENTION

Accordingly, it is an aspect of the present invention to provide a method and an apparatus capable of using a strong image system of a television in a personal computer screen like an application.

Another aspect of the present invention is to provide an image processing apparatus, a display apparatus and a control method of the display apparatus embodying a strong multimedia system of the display apparatus, and concurrently, conveniently controlling a multimedia system embodied in the display apparatus through the image processing apparatus by interaction between the image processing apparatus and the display apparatus.

The present invention provides a display apparatus, including: a communication unit which receives a first image from an image processing apparatus; an image processing unit which processes the first image which is received through the communication unit and a second image; a display unit which displays the first image and the second image which are processed by the image processing unit; and a control unit which controls the image processing unit so that the second image which is displayed in the display unit can be adjusted depending on a control of the image processing apparatus.

The second image may be an image of the display apparatus, or may be input from another image processing apparatus except the image processing apparatus which sends the first image.

The second image may include an image screen or an internal on screen display (OSD).

The control unit may control the image processing unit so that the first image which is displayed in the display unit can be adjusted depending on a control of the image processing apparatus.

The control unit may control the image processing unit to adjust at least one of the position and size of the first image or the second image depending on a control of the image processing apparatus.

The control unit may control the image processing unit to change the first image or the second image to another image depending on a control of the image processing apparatus.

The control unit may control the image processing unit to output the first image and the second image in a single screen in a picture in picture (PIP) type or a double window type.

The present invention provides an image processing apparatus, including: an image processing unit which processes a first image; a communication unit which sends the first image which is processed by the image processing unit to a display apparatus; a user interface unit which receives a control command from a user; and a control unit which controls the display apparatus so that the second image which is displayed in the display apparatus can be adjusted depending on a control command which is input through the user interface unit.

The control unit may control the display apparatus so that the first image which is displayed in the display apparatus can be adjusted.

The control unit may control the display apparatus to adjust at least one of the position and size of the first image or the second image depending on an input control command.

The control unit may control the display apparatus to change the first image or the second image to another image depending on an input control command.

The present invention provides a control method of a display apparatus, including: processing and displaying a first image which is received from an image processing apparatus; processing a second image, and displaying the second image together with the first image; and adjusting the second image which is displayed in the display apparatus depending on a control of the image processing apparatus.

The second image may be an image of the display apparatus, or may be input from another image processing apparatus except the image processing apparatus which sends the first image.

The second image may include an image screen or an internal on screen display (OSD).

The control method of the display apparatus may further include adjusting the first image which is displayed in the display apparatus depending on a control of the image processing apparatus.

At least one of the position and size of the first image or the second image may be adjusted depending on a control of the image processing apparatus.

The first image or the second image may be changed to another image depending on a control of the image processing apparatus.

The first image and the second image may be displayed in a single screen in a picture in picture (PIP) type or a double window type.

### BRIEF DESCRIPTION OF DRAWINGS

The exemplary embodiments of the present invention will become apparent and more readily appreciated from the following description of the exemplary embodiments, taken in conjunction with the accompanying drawings, in which:

FIG. 1 is a drawing illustrating a configuration of a display apparatus according to an exemplary embodiment of the present invention;

FIG. 2 is a drawing illustrating a configuration of an image processing apparatus according to an exemplary embodiment of the present invention;

FIG. 3A is a drawing illustrating an image displayed depending on a control method of a display apparatus according to a first exemplary embodiment of the present invention;

FIG. 3B is a drawing illustrating an image controlled depending on the control method of the display apparatus according to the first exemplary embodiment of the present invention;

FIG. 3C is a drawing illustrating an image controlled depending on the control method of the display apparatus according to the first exemplary embodiment of the present invention;

FIG. 4A is a drawing illustrating an image displayed depending on a control method of a display apparatus according to a second exemplary embodiment of the present invention;

FIG. 4B is a drawing illustrating an image controlled depending on the control method of the display apparatus according to the second exemplary embodiment of the present invention;

FIG. 4C is a drawing illustrating an image controlled depending on the control method of the display apparatus according to the second exemplary embodiment of the present invention;

FIG. 5 is a drawing illustrating a control process of the display apparatus according to the first exemplary embodiment of the present invention; and

FIG. 6 is a drawing illustrating a control process of the display apparatus according to the second exemplary embodiment of the present invention.

### DETAILED DESCRIPTION OF EXEMPLARY EMBODIMENTS

Reference will now be made in detail to the embodiments of the present invention, examples of which are illustrated in the accompanying drawings, wherein like reference numerals refer to like elements throughout. The exemplary embodiments are described below so as to explain the present invention by referring to the figures. Repetitive description with respect to like elements of different embodiments may be omitted for the convenience of clarity.

An image processing apparatus and a display apparatus according to an exemplary embodiment of the present invention may be respectively implemented as a digital television (TV), a desktop computer, a laptop computer, a mobile terminal, a personal digital assistant (PDA), etc. Further, an image processing apparatus and a display apparatus according to an exemplary embodiment of the present invention may be implemented as an apparatus capable of performing an interactive communication (for example, an internet function) and an image processing function.

The image processing apparatus and the display apparatus interact with each other, and accordingly, are capable of controlling images displayed in the opposite apparatuses. In detail, a user may control an image displayed in the display apparatus through the image processing apparatus, or control an image displayed in the image processing apparatus through the display apparatus. For this, the image processing apparatus and the display apparatus send and receive information necessary for an image control and an image control information through communication between the apparatuses.

Hereinafter, the display apparatus and the image processing apparatus will be described in detail.

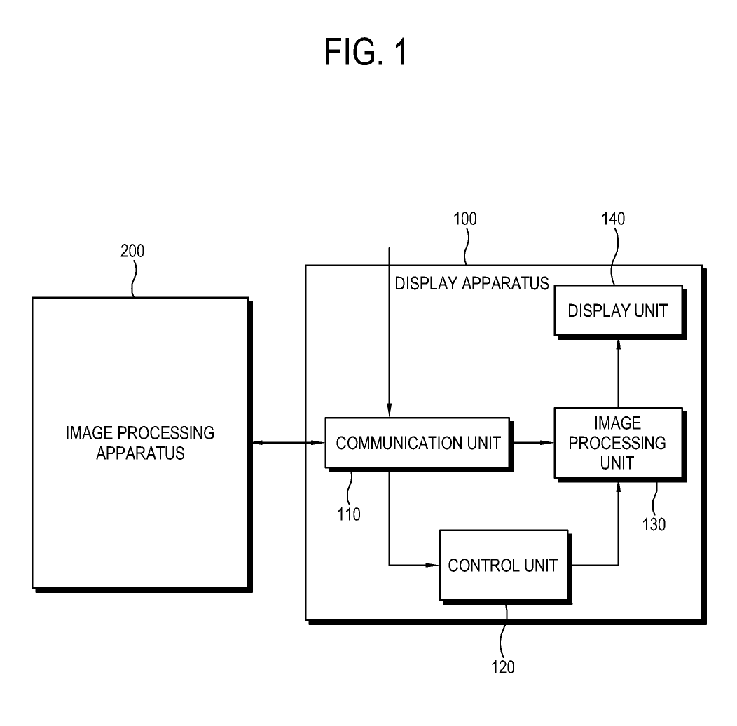

FIG. 1 is a drawing illustrating a configuration of a display apparatus according to an exemplary embodiment of the present invention.

A display apparatus 100 may include a communication unit 110, a control unit 120, an image processing unit 130 and a display unit 140.

The communication unit 110 receives a video signal from an outside. Here, the video signal means all input signals capable of being connected to the display apparatus 100. For example, the video signal may be input through a set top box, an internet protocol (IP) TV, a universal serial bus (BUS), a digital versatile disk (DVD)/blu-ray disk (BD) players, a radio frequency (RF) transmitting device, etc. connected to the display apparatus 100.

Hereinafter, a video signal received from an image processing apparatus 200 controlling the display apparatus 100 refers to a first image, and other video signals refer to a second image. In this case, the second image may be an image of the display apparatus 100, or an image input from other image processing apparatuses except the image processing apparatus 200 sending the first image. In detail, the second image may be an image screen or an internal on screen display (OSD).

The communication unit 110 may transmit information for a control of the first image to the image processing apparatus 200 if receiving the first image from the image processing apparatus 200. In detail, the information for the control of the first image may be information about the position and size of the first image displayed in the display apparatus 100, etc. Also, the communication unit 110 may transmit information for a control of the second image to the image processing apparatus 200. In an exemplary embodiment, the image processing apparatus 200 can transmit the information for the control of the second image to other image processing apparatuses. In detail, the information for the control of the second image may be information about an image quality setting information of image, a channel information, an input terminal, etc.

The control unit 120 controls the image processing unit 130 depending on a control of the image processing apparatus 200 so that the first image or the second image displayed in the display unit 140 can be adjusted. In detail, the control unit 120 may control the image processing unit 130 to adjust at least one of the position and size of the first image or the second image, or to change the first image or the second image into other images.

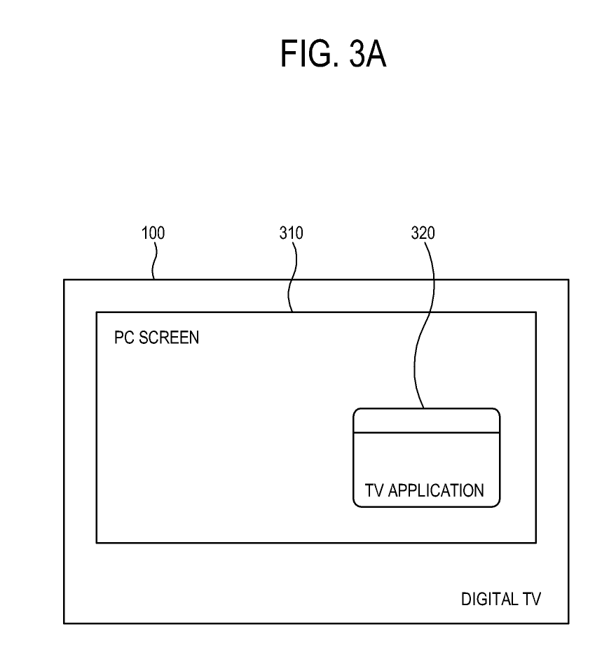

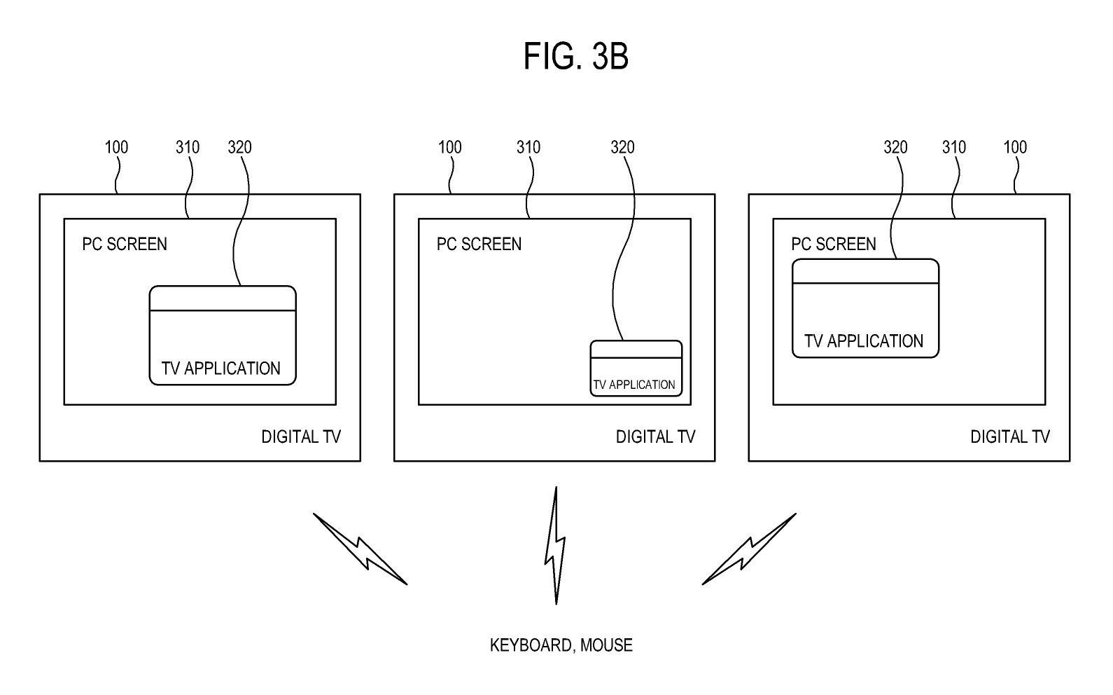

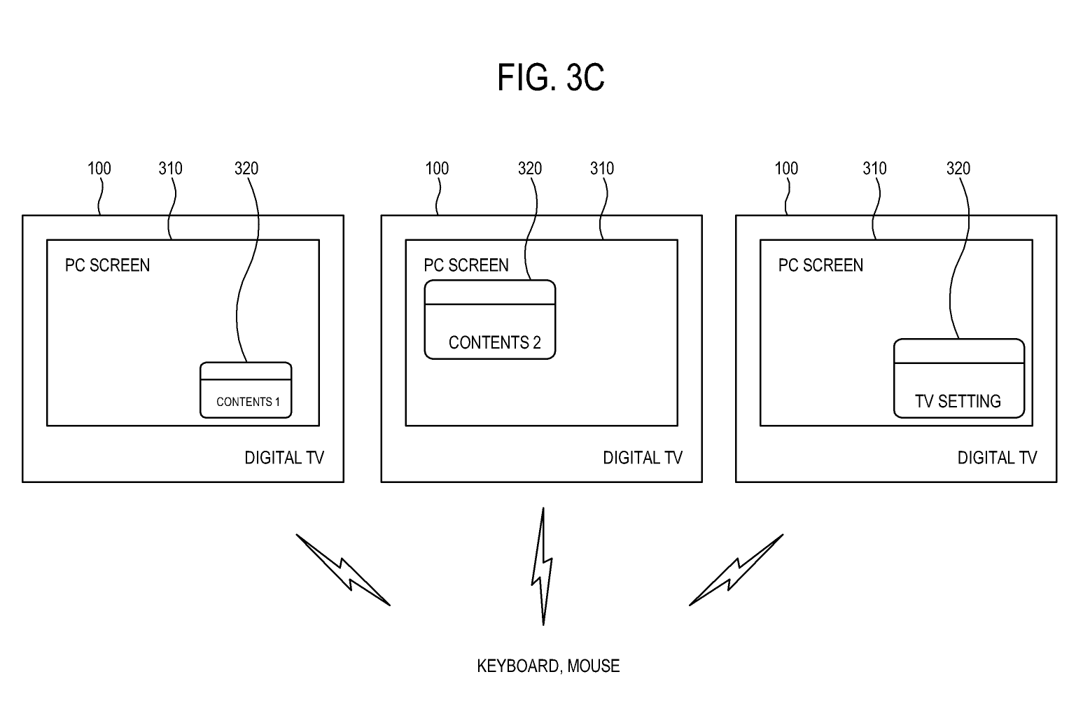

Also, the control unit 120 may control the image processing unit 130 to output the first image and the second image in a single screen in a picture in picture (PIP) type arrangement or a double window type arrangement (See FIG. 3A). In a double window type arrangement, two or more active windows are displayed on a screen. In another exemplary embodiment, in a double window type arrangement there are two or more active windows displayed on a screen when two or more applications are being executed.

The image processing unit 130 processes the first image and the second image received through the communication unit 110. In detail, the image processing unit 130 may perform scaling for the first image and the second image to be appropriate for a screen, or appropriately adjust the brightness or darkness of the images.

The display unit 140 displays the first image and the second image processed by the image processing unit 130. In this case, the display unit 140 may display the first image and the second image in a single screen in a PIP type arrangement or a double window type arrangement.

Also, the display unit 140 may be implemented as a liquid crystal display (LCD), an organic light emitting diode (OLED), a plasma display panel (PDP), etc.

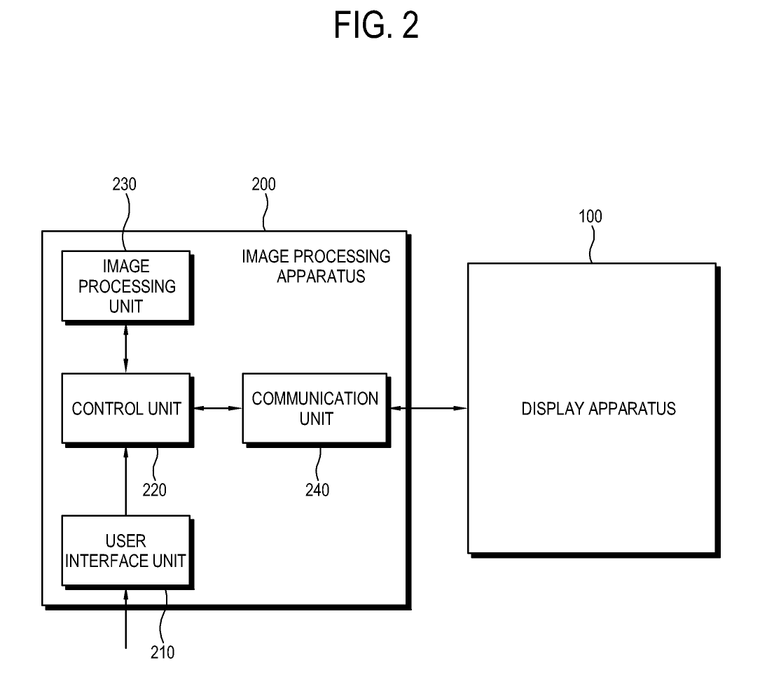

FIG. 2 is a drawing illustrating a configuration of an image processing apparatus according to an exemplary embodiment of the present invention.

An image processing apparatus 200 may include a user interface unit 210, a control unit 220, an image processing unit 230 and a communication unit 240.

The user interface unit 210 receives a control command from a user. For example, if the image processing apparatus 200 is a digital television (TV), the user may input the control command through an input button attached to the digital TV, or an external input device such as a remote controller remotely adjusting the digital TV, etc. If the image processing apparatus 200 is a personal computer (PC), the user may input the control command through a keyboard or a mouse connected to the PC.

The image processing unit 230 processes a video signal input to the image processing apparatus 200 from an outside. In detail, the image processing unit 230 may demodulate a received video signal to an original signal, and perform scaling to be appropriate for a screen or appropriately adjust the brightness or darkness of the image.

If the image processing apparatus 200 sends the first image displayed in the image processing apparatus 200 to the display apparatus 100, the image processing unit 230 processes the first image to be appropriate for a transmission format.

The control unit 220 controls the display apparatus 100 depending on a control command input through the user interface unit 210 so that the first image or the second image displayed in the display apparatus 100 can be adjusted.

In detail, the control unit 220 may control the display apparatus 100 to adjust at least one of the position and size of the first image or the second image, or to change the first image or the second image to other images.

The communication unit 240 sends the first image processed by the image processing unit 230 to the display apparatus 100.

The communication unit 240 may receive information for a control of the first image or the second image from the display apparatus 100.

FIG. 3A is a drawing illustrating an image displayed depending on a control method of a display apparatus according to a first exemplary embodiment of the present invention.

According to the first exemplary embodiment, the image processing apparatus 200 is a PC, and the display apparatus 100 is a digital TV.

The first image processed in the PC 200 and the second image processed in the digital TV 100 are concurrently displayed in the digital TV 100. In this case, the first image and the second image may be output in a PIP type arrangement or a double window type arrangement. In the digital TV 100 in FIG. 3A, a PC screen 310 corresponding to the first image and a TV application 320 corresponding to the second image are concurrently displayed in the PIP type arrangement. One of the PC screen 310 and the TV application 320 is displayed as a main screen (or a sub screen) according to a user selection. FIG. 3A shows the PC screen 310 being displayed as the main screen.

FIG. 3B is a drawing illustrating an image controlled depending on the control method of the display apparatus according to the first exemplary embodiment of the present invention.

Conventionally, the PC screen 310 or the digital TV screen 320 displayed in the digital TV 100 is capable of being adjusted through only the digital TV 100. However, in the present invention, the PC screen 310 or the digital TV screen 320 displayed in the digital TV 100 is capable of being controlled through the PC 200. In a PC environment, by using a mouse, a window displayed in a screen can be dragged to change the position thereof, and the size of the window can be freely adjusted. Also, by using a shortcut key of a keyboard, various functions can be available. This is a very convenient function for a user side. Accordingly, if the PC screen 310 or the digital TV screen 320 displayed in the digital TV 100 is controlled by the PC 200 like the first exemplary embodiment of the present invention, a user can easily control many images. Further, since the screens are displayed in the digital TV 100, the images can be embodied through a strong image system which the digital TV 100 has.

As shown in FIG. 3B, the user can adjust the position of the TV application 320 displayed in the digital TV 100 to a central part, a right lower part, a left upper part, etc., by using the mouse or the keyboard. Also, the size of the TV application 320 can be adjusted by using the mouse or the keyboard. Also, the user can adjust the PC screen 310 with the same method.

FIG. 3C is a drawing illustrating an image controlled depending on the control method of the display apparatus according to the first exemplary embodiment of the present invention.

According to the first exemplary embodiment of the present invention, while viewing the PC screen 310 in the digital TV 100, the user can view and adjust contents visible through the digital TV 100 like an application by using the mouse or the keyboard.

For example, if the display apparatus 100 currently displays the second image 320 which is a video signal received from an air wave broadcasting station and processed, the user may change the second image 320 to other contents or a TV setting. Referring to FIG. 3C, the second image 320 is illustrated to be changed to a contents 1, a contents 2, a TV setting or the like. In this case, each contents may be input through a set top box, an internet protocol (IP) TV, a universal serial bus (USB), digital versatile disk (DVD)/blu-ray disk (BD) players, a radio frequency (RF) transmitting device, etc. Also, the TV setting may be an on screen display (OSD) adjusting resolution, brightness, darkness, etc. of an image displayed in the digital TV 100, etc.

Conventionally, contents visible through the digital TV 100 are adjusted in the digital TV 100. That is, by using a remote controller or an input button of the digital TV 100, it is changed with an external input, or an input image source is changed.

However, according to the first exemplary embodiment of the present invention, contents visible through the digital TV 100 can be adjusted, or a channel change or a screen setting can be performed in the PC 200. For example, if a user wants to view a motion picture existing in a USB device while viewing a digital broadcasting, the user can click a mouse to delete an image displayed in the TV application 320, and drag the contents stored in the USB device to the TV application 320. Also, the user can perform a file selection, an image quality adjustment, etc. by using an OSD supplied through a software inside the digital TV 100. Also, the user can perform the adjustment by using a shortcut key of a keyboard instead of the mouse. In this case, the user can conveniently and easily control the TV application 320 without pressing an input button several times.

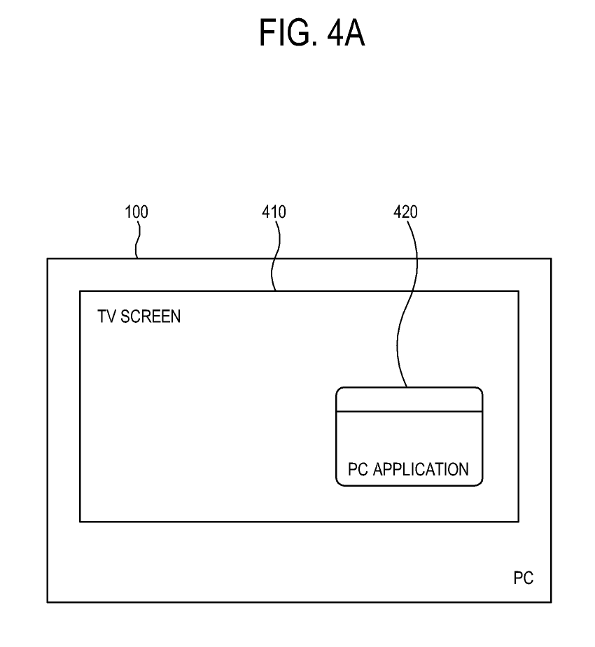

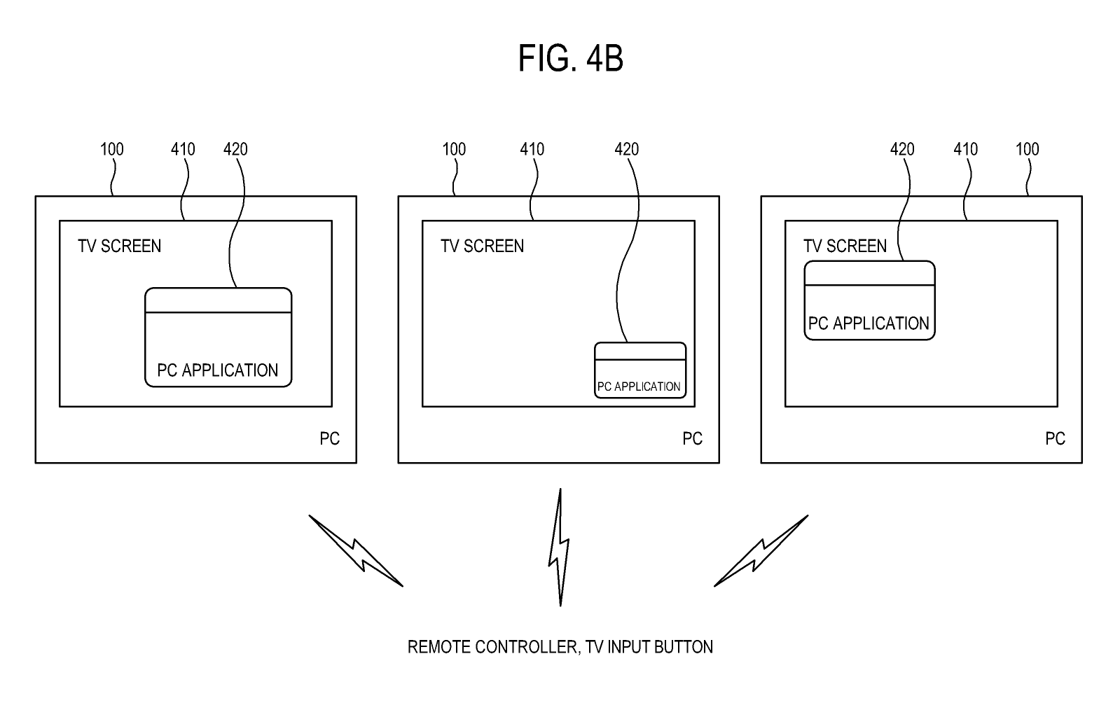

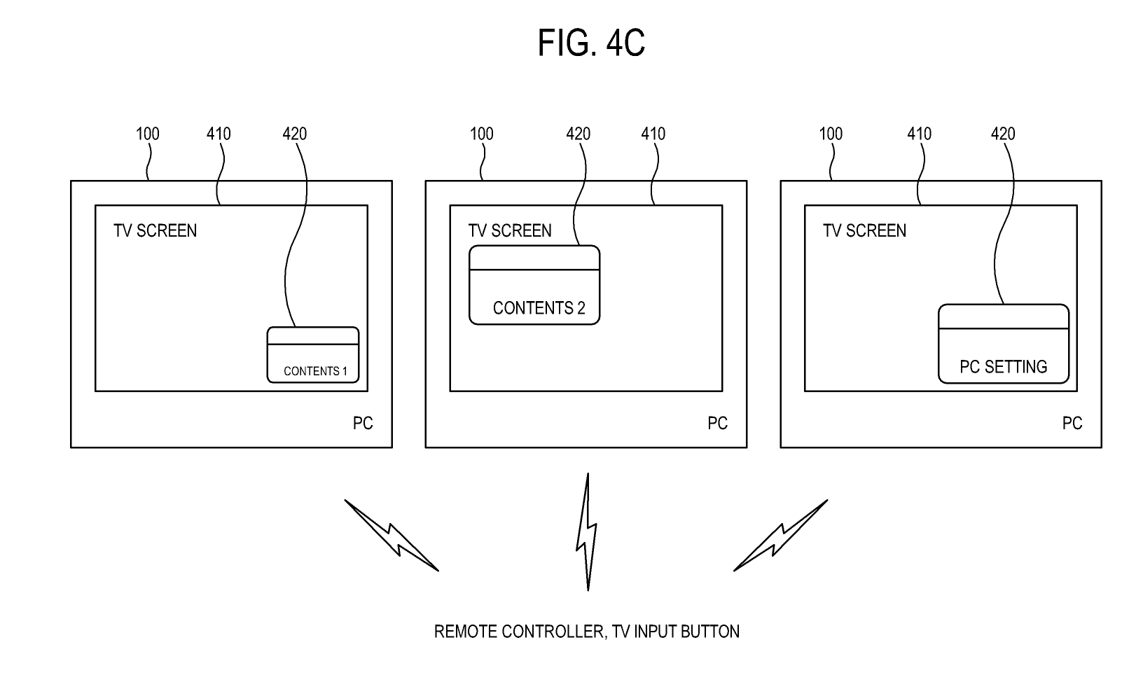

FIG. 4A is a drawing illustrating an image displayed depending on a control method of a display apparatus according to a second exemplary embodiment of the present invention.

According to the second exemplary embodiment, the image processing apparatus 200 is a digital TV, and the display apparatus 100 is a PC.

The first image processed in the digital TV 200 and the second image processed in the PC 100 are concurrently displayed in the PC 100. In the PC 100 in FIG. 4A, a TV screen 410 corresponding to the first image and a PC application 420 corresponding to the second image are concurrently displayed in the PIP type arrangement.

FIG. 4B is a drawing illustrating an image controlled depending on the control method of the display apparatus according to the second exemplary embodiment of the present invention.

Conventionally, the TV screen 410 or the PC screen 420 displayed in the PC 100 is capable of being adjusted through only the PC 100. However, in the present invention, the TV screen 410 or the PC screen 420 displayed in the PC 100 is capable of being controlled through the digital TV 200. In a TV environment, by using a remote controller or an input button, a channel displayed in a screen can be changed, or a TV setting can be changed. Further, in the TV environment, all control commands which are capable of being processed in the TV can be transmitted to the TV through the input button or the remote controller. All a user needs to do is press the input button or the remote controller, or touch (for example, in case of being implemented as a touch pad) with no peculiar action. Furthermore, in case of using the remote controller, a remote control is available. Accordingly, if the first image 410 and the second image 420 displayed in the PC 100 are controlled by the digital TV 200 like the second exemplary embodiment of the present invention, the user can easily control the images.

As shown in FIG. 4B, the user can adjust the position of the PC application 420 displayed in the PC 100 to a right lower part, a left upper part, etc. by using the remote controller or the input button. In detail, by pressing arrow buttons ←, ↑, →, ↓, [symbol] , and [symbol] positioned to the remote controller, the application 420 can be changed to have a desired position. Also, the size of the PC application 420 can be adjusted by using the remote controller or the input button.

FIG. 4C is a drawing illustrating an image controlled depending on the control method of the display apparatus according to the second exemplary embodiment of the present invention.

According to the second exemplary embodiment of the present invention, while viewing a screen of the digital TV 200 in the PC 100, the user can view and adjust contents visible through the PC 100 like an application by using the remote controller or the input button.

For example, if the PC 100 currently executes an MICROSOFT WORD program on a window, an executing screen of the MICROSOFT WORD program becomes the second image 420. In this case, the user may change the second image 420 to other contents or a PC setting. Referring to FIG. 4C, the second image 420 is illustrated to be changed to a contents 1, a contents 2, a PC setting or the like. In this case, each contents may be input to the PC 100 through a set top box, an internet protocol (IP) TV, a universal serial bus (USB), digital versatile disk (DVD)/blu-ray disk (BD) players, a radio frequency (RF) transmitting device, etc. Also, the PC setting may be an on screen display (OSD) adjusting resolution, brightness, darkness, etc. of an image displayed in the PC 100, etc.

Conventionally, contents visible through the PC 100 are adjusted in the PC 100. That is, by using a mouse or a keyboard, it is changed with an external input, or an executed program is changed.

However, according to the second exemplary embodiment of the present invention, contents visible through the PC 100 can be adjusted in the digital TV 200. For example, the user may press the input button attached to the digital TV 200 or the input button of the remote controller to change a contents displayed in the PC application 420, or change a program in operation. In this case, the user can easily control the PC application 420 with just pressing the input button without a specific action.

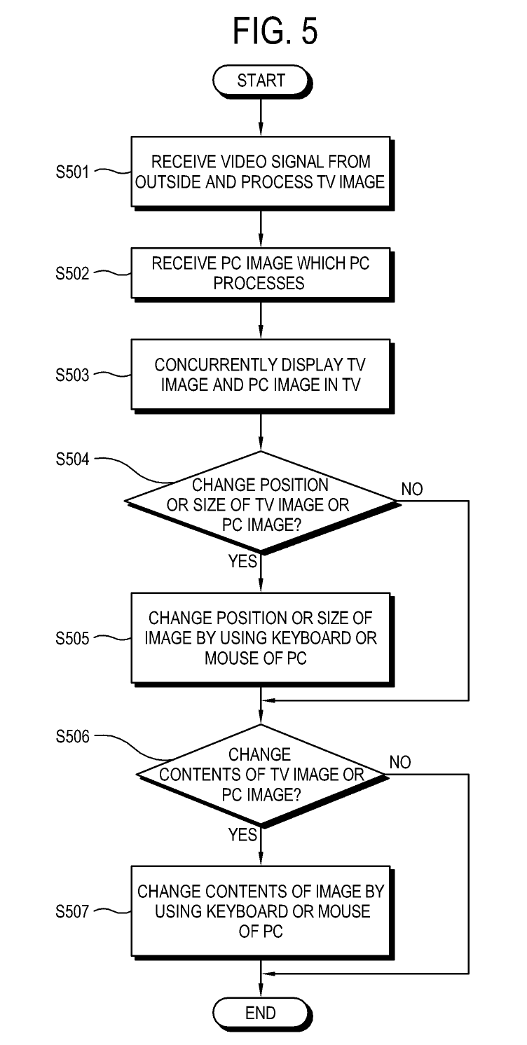

FIG. 5 is a drawing illustrating a control process of the display apparatus according to the first exemplary embodiment of the present invention.

In the first exemplary embodiment, as described above, the image processing apparatus 200 is implemented as a PC, and the display apparatus 100 is implemented as a digital TV.

According to the first exemplary embodiment of the present invention, while concurrently viewing a PC screen and contents visible through the TV in the digital TV 100, a user can adjust a screen displayed in the display apparatus 100 like an application through the PC 200.

The digital TV 100 receives a video signal from an outside, and processes a TV image (S501). The TV image which the digital TV 100 processes corresponds to the second image.

The digital TV 100 receives a PC image which the PC 200 processes (S502). The PC image corresponds to the first image. In this case, the PC image may be a screen according to execution of an internal program of the PC 200, or an image input from an outside and processed in the PC 200.

The digital TV 100 concurrently displays the TV image and the PC image in a screen (S503). In this case, the TV image and the PC image may be displayed in a PIP type arrangement or a double window type arrangement.

A user determines whether to change the position or size of the TV image or the PC image through the PC 200 or not (S504). If the user wants to change the position or size of the TV image or the PC image, the user presses a keyboard of the PC 200, or drags a mouse to change the position or size of the image (S505).

The user determines whether to change contents of the TV image or the PC image through the PC 200 or not (S506). If the user wants to change the contents of the TV image or the PC image, the user presses the keyboard of the PC 200, or drags the mouse to change the contents of the image (S507).

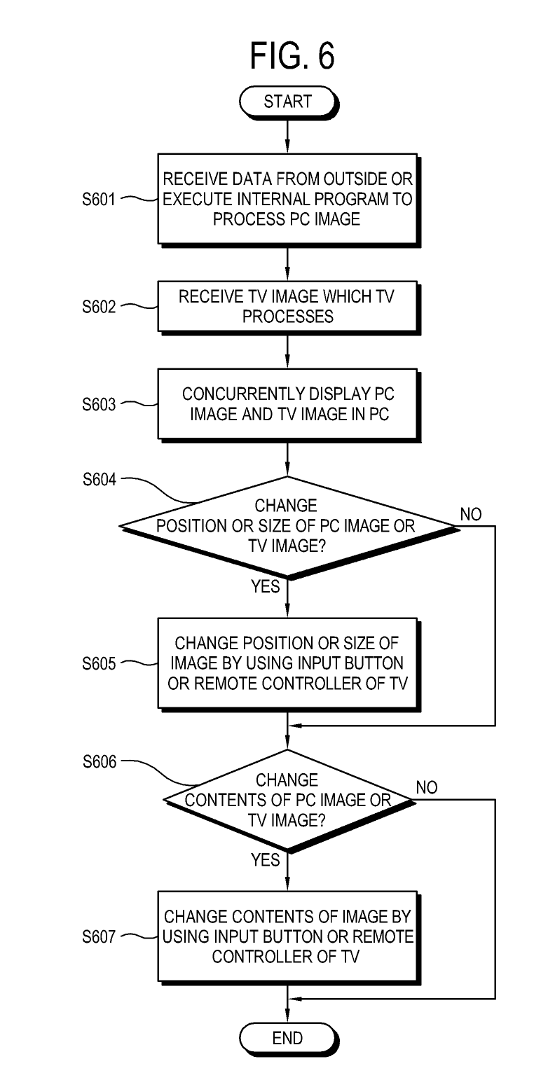

FIG. 6 is a drawing illustrating a control process of the display apparatus according to the second exemplary embodiment of the present invention.

In the second exemplary embodiment, the image processing apparatus 200 is implemented as a digital TV, and the display apparatus 100 is implemented as a PC. This is different from the first exemplary embodiment.

According to the second exemplary embodiment of the present invention, while concurrently viewing a TV screen and contents executable or visible through the PC in the PC 100, a user can adjust a screen displayed in the PC 100 like an application through the digital TV 200.

The PC 100 receives a data from an outside, or executes an internal program to process a PC image (S601). The PC image which the PC 100 processes corresponds to the second image.

The PC 100 receives a TV image which the digital TV 200 processes (S602). The TV image corresponds to the first image. In this case, the TV image may be an image input from an outside and processed in the digital TV 200.

The PC 100 concurrently displays the PC image and the TV image in a screen (S603). In this case, the PC image and the TV image may be displayed in a PIP type arrangement or a double window type arrangement.

A user determines whether to change the position or size of the PC image or the TV image through the digital TV 200 or not (S604). If the user wants to change the position or size of the PC image or the TV image, the user uses an input button of the digital TV 200 or a remote controller to change the position or size of the image (S605).

The user determines whether to change contents of the PC image or the TV image through the digital TV 200 or not (S606). If the user wants to change the contents of the PC image or the TV image, the user uses the input button of the digital TV 200 or the remote controller to change the contents of the image (S607). With this, the control process of the display apparatus according to the second exemplary embodiment of the present invention is ended.

According to the present invention, an image system such as a picture in picture (PIP), a motion picture replay, an image quality processing, etc. mounted to a digital television is supplied like an application through interaction between the digital television and a personal computer, thereby supplying a best multimedia function.

Also, an image screen displayed in a digital television can be easily controlled through a personal computer.

Although a few exemplary embodiments of the present invention have been shown and described, it will be appreciated by those skilled in the art that changes may be made in these exemplary embodiments without departing from the principles and spirit of the invention, the scope of which is defined in the appended claims and their equivalents.

What is claimed is:

1. A display apparatus, comprising:
a communication unit which receives a first image from an image processing apparatus;
an image processing unit which processes the first image which is received through the communication unit and a second image;
a display unit which displays the first image and the second image which are processed by the image processing unit; and
a control unit which controls the image processing unit so that the second image which is displayed in the display unit can be adjusted depending on a control of the image processing apparatus.

2. The display apparatus according to claim 1, wherein the second image is an image of the display apparatus, or is input from another image processing apparatus other than the image processing apparatus which sends the first image.

3. The display apparatus according to claim 2, wherein the second image comprises an image screen or an on screen display (OSD).

4. The display apparatus according to claim 1, wherein the control unit controls the image processing unit so that the first image which is displayed in the display unit can be adjusted depending on a control of the image processing apparatus.

5. The display apparatus according to claim 4, wherein the control unit controls the image processing unit to adjust at least one of a position and a size of the first image or at least one of a position and a size of the second image depending on a control of the image processing apparatus.

6. The display apparatus according to claim 4, wherein the control unit controls the image processing unit to change the first image or the second image to another image depending on a control of the image processing apparatus.

7. The display apparatus according to claim 1, wherein the control unit controls the image processing unit to output the first image and the second image in a single screen in a picture in picture (PIP) type arrangement or a double window type arrangement.

8. An image processing apparatus, comprising:
an image processing unit which processes a first image;
a communication unit which sends the first image which is processed by the image processing unit to a display apparatus;
a user interface unit which receives a control command from a user; and
a control unit which controls the display apparatus so that the second image which is displayed in the display apparatus is adjusted depending on a control command which is input through the user interface unit.

9. The image processing apparatus according to claim 8, wherein the control unit controls the display apparatus so that the first image which is displayed in the display apparatus is adjusted.

10. The image processing apparatus according to claim 9, wherein the control unit controls the display apparatus to adjust at least one of a position and a size of the first image or at least one of a position and a size of the second image depending on an input control command.

11. The image processing apparatus according to claim 9, wherein the control unit controls the display apparatus to change the first image or the second image to another image depending on an input control command.

12. A control method of a display apparatus, comprising:
processing and displaying a first image which is received from an image processing apparatus;
processing a second image, and displaying the second image together with the first image; and
adjusting the second image which is displayed in the display apparatus depending on a control of the image processing apparatus.

13. The control method of the display apparatus according to claim 12, wherein the second image is an image of the display apparatus, or is input from another image processing apparatus other than the image processing apparatus which sends the first image.

14. The control method of the display apparatus according to claim 13, wherein the second image comprises an image screen or an on screen display (OSD).

15. The control method of the display apparatus according to claim 12, further comprising adjusting the first image which is displayed in the display apparatus depending on a control of the image processing apparatus.

16. The control method of the display apparatus according to claim 15, wherein at least one of a position and a size of the first image or at least one of a position and a size of the second image is adjusted depending on a control of the image processing apparatus.

17. The control method of the display apparatus according to claim 15, wherein the first image or the second image is changed to another image depending on a control of the image processing apparatus.

18. The control method of the display apparatus according to claim 12, wherein the first image and the second image are displayed in a single screen in a picture in picture (PIP) type arrangement or a double window type arrangement.

19. A display control method of a first device, the first device communicating with a second device, the method comprising:
displaying at the first device a video image not received from the second device;
receiving a user input at the second device, for controlling the displaying of the video image and generating a user control signal;
receiving by the first device, the user control signal from the second device to adjust the display of the video image at the first device.
